(19) United States
(12) Patent Application Publication
(10) Pub. No.: US 2018/0106583 A1
(43) Pub. Date: Apr. 19, 2018

(54) REMOTE FIRING SYSTEM FOR NON-ELECTRIC DETONATORS USING ELECTRONIC INITIATORS

(71) Applicant: MaxamCorp Holding, S.L., Madrid (ES)

(72) Inventors: Luis Diego Montaño Rueda, Galdácano-Vizcaya (ES); Jose María Ayensa Muro, Galdácano-Vizcaya (ES)

(21) Appl. No.: 15/562,835

(22) PCT Filed: Mar. 30, 2016
(86) PCT No.: PCT/EP2016/056882

§ 371 Date: Sep. 28, 2017

(30) Foreign Application Priority Data
Mar. 30, 2015 (EP) 15382157.4

(51) Int. Cl. F42D 1/055; F42D 1/04; F42D 1/06; H04W 84/18

(52) U.S. Cl. CPC F42D 1/055; F42D 1/043; H04W 84/18; F42D 1/042; F42D 1/06

(57) ABSTRACT

A firing system comprising an electronic initiator, and a blasting unit connected to and capable to initiate the electronic initiator, wherein the electronic initiator comprises an external housing made of plastics, an explosive charge, a fuse head and an electronic delay element, the external housing comprising an inner cavity and retaining means adapted to retain at least one shock tube, the explosive charge, the fuse head and the electronic delay element being located in the inner cavity of the external housing, the explosive charge being located at a closed end of the inner cavity, at a position such that the explosive charge is capable to ignite the shock tubes retained by the retaining means in a use situation of the electronic initiator, the fuse head and the explosive charge being located relative to each other such that the fuse head is capable to ignite the explosive charge, and the electronic delay element being connected to the fuse head and being configured to initiate it.

### TECHNICAL FIELD OF THE INVENTION

The present invention refers to a remote firing system which comprises an electronic initiator and which is usable for the initiation of blasts using non-electric detonators, specifically non-electric detonators initiated via shocktubes.

The remote firing system of the invention is usable in mining, large-scale public works and generally for any other practical situation where it is necessary to carry out controlled blasts, either in underground or in open pit.

### BACKGROUND OF THE INVENTION

Local firing has the disadvantage of needing a shocktube trunk line to be extended until the blasting central point, which makes the safety distance for each blast critical for the user of the equipment and also because of the budget necessary for the extension of shocktube for each blast.

Remote firing systems allow the users to have the possibility to accommodate themselves in the most appropriate area to execute the blast without compromising their safety and reducing costs associated to the use of shocktube.

Current remote initiation systems include a blasting unit connected to a non-electric shocktube for the initiation of non-electric detonators. These systems use a high DC voltage to generate a spark through an electrode. The spark is generated inside the shocktube and in constant contact with the inner explosive that ignites the shocktube. A remote device can be used to command the system from a distance.

However, these systems have a problem of reliability, because the electrodes that are used to initiate the shocktube have a high percentage of misfires due to several reasons, among which the following can be mentioned: incorrect shape of the electrodes, small amount of explosive inside the shocktube, ignition causing the shocktube to slip away from the equipment, and even the excessively short shelf life of the electrode itself.

If the remote control sends the fire command to the blasting unit connected to the non-electric shocktube and the blasting unit fails in initiating the shocktube, it requires somebody to go back to the firing field and to reconnect the shocktube and the electrode and then going back to a safe area to allow the fire. This results in safety and economic issues.

There is thus a need for a remote firing system with improved reliability.

### DESCRIPTION OF THE INVENTION

The above mentioned problems are solved by means of a remote firing system according to claim 1. Preferred embodiments of the invention are defined in the dependent claims.

The firing system of the invention comprises at least one electronic initiator and a blasting unit connected to the at least one electronic initiator by means of at least one wire. The electronic initiator comprises an external housing, an explosive charge, a fuse head and an electronic delay element. The external housing is made of plastics and comprises an inner cavity and retaining means adapted to retain at least one shocktube. The explosive charge, the fuse head and the electronic delay element are located in the inner cavity of the external housing. The explosive charge is located at a closed end of the inner cavity, at a position such that the explosive charge is capable to ignite the shocktubes retained by the retaining means in a use situation of the electronic initiator. The fuse head and the explosive charge are located relative to each other such that the fuse head is capable to ignite the explosive charge. The electronic delay element is connected to the fuse head and is configured to initiate it.

The blasting unit is placed out of the external housing of the electronic initiator. In other words, the electronic initiator and the blasting unit are separate elements suitable for being placed at remote locations one from the other.

The blasting unit is configured for providing the electronic initiator through the at least one wire with an initiation voltage which is sufficient to initiate the fuse head, and with the proper digital codes that the electronic initiator can identify and understand to execute the functions ordered by the blasting unit.

Advantageously, the present invention provides a reliable and safe way to initiate non-electric blasts through remote control.

According to the invention, the blasting unit is capable to initiate the at least one electronic initiator connected thereto and, in consequence, initiating the at least one shocktube attached and held by the retaining means of the external housing in a use situation of the firing system.

In an embodiment of the invention the electronic initiator further comprises a sealing plug located in the inner cavity, sealing an open end thereof.

In a preferred embodiment the weight of the explosive charge of an electronic initiator is less than 500 mg.

In an embodiment of the invention the retaining means of the electronic initiator comprise at least one slot adapted to receive at least one shocktube. In a preferred embodiment the at least one slot is situated adjacent to the explosive charge.

In an embodiment of the invention the electronic delay element is an electronic circuit programmable to set a delay time.

In an embodiment of the invention the blasting unit is remotely controllable. Preferably, the blasting unit is remotely controllable using wireless technology.

In an embodiment of the invention the firing system further comprises a control unit adapted to remotely control the blasting unit to initiate the electronic initiator.

In an embodiment of the invention the firing system comprises a plurality of electronic initiators connected to the blasting unit. In an embodiment the electronic initiators are programmable to initiate respective blasts sequentially in time. Advantageously, it is thus possible to assign time sequences between the plurality of electronic initiators connected to the blasting unit.

In an embodiment, the firing system comprises a plurality of blasting units and a plurality of electronic initiators, each blasting unit being connected to at least one electronic initiator. In an embodiment the blasting units are programmable to initiate the electronic initiators sequentially in time.

In an embodiment the blasting unit comprises communication means configured to allow communication with at least one additional blasting unit. In a preferred embodiment the communication means are configured to allow bidirectional communication between at least two blasting units, such that instructions and/or commands can be sent between them. The communication interface of the communication means can be wired or wireless. In a preferred embodiment the communication means are configured to operate in ad-hoc mode and/or in infrastructure network. Advantageously, the blasting units are thus capable to communicate in open pit mines or underground operations. In ad-hoc mode the blasting units directly communicate with each other, in peer-to-peer mode, without requiring access points. In infrastructure network mode the blasting units communicate with each other by first going through an access point of an existing communications infrastructure.

All the features and/or methods steps described in this specification (including the claims, description and drawings) can be combined in any way except in those combinations of such mutually exclusive features.

### DESCRIPTION OF THE DRAWINGS

These and other characteristics and advantages of the invention will become clearly understood in view of the detailed description of the invention which becomes apparent from preferred embodiments of the invention, given just as an example and not being limited thereto, with reference to the drawings.

FIG. 1 shows a schematic picture of a firing system according to an embodiment of the invention.

FIG. 2 shows a cross section of the electronic initiator according to an embodiment of the firing system of the invention.

FIG. 3 shows a cross section of an electronic initiator as the one shown in FIG. 2, retaining a number of shocktubes.

FIG. 4 shows a schematic picture of a firing system according to an embodiment of the invention.

### DETAILED DESCRIPTION OF THE INVENTION

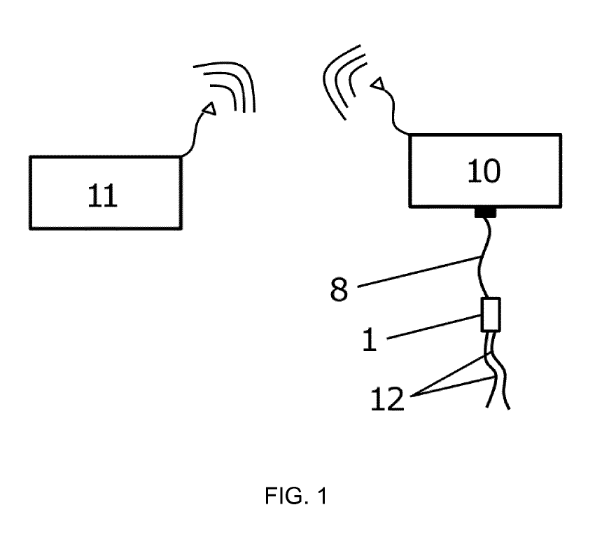

FIG. 1 schematically shows a firing system according to an embodiment of the invention. In this embodiment, the firing system comprises an electronic initiator (1) and a blasting unit (10) connected through at least one wire (8) to the electronic initiator (1) and adapted to initiate the electronic initiator. The firing system further comprises a control unit (11) adapted to remotely control the blasting unit (10) to initiate the electronic initiator (1). In this embodiment the control of the blasting unit is based on wireless technology.

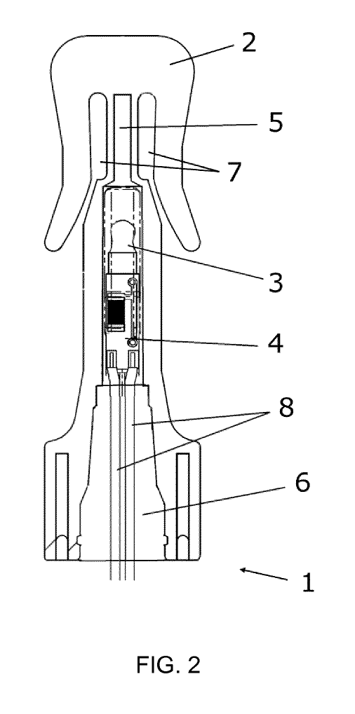

FIG. 2 shows an electronic initiator (1) according to an embodiment of the invention. The electronic initiator (1) comprises an external housing (2) made of plastics, an inner cavity and retaining means adapted to retain at least one shocktube. In this embodiment the external housing has two slots (7) for receiving each a plurality of shocktubes.

The electronic initiator (1) includes an explosive charge (5), a fuse head (3) and an electronic delay element (4) located within the inner cavity of the external housing (2). As shown in the figure, the external housing (2) has a closed end at which the explosive charge (5) is located. The explosive charge (5) is located relative to the retaining means such that the explosive charge (5) is capable to ignite the shocktubes retained by the retaining means in a use situation of the electronic initiator (1). In this embodiment the explosive charge (5) is located along an elongated portion of the inner cavity and the retaining means, configured as two slots, are adjacent and parallel to the explosive charge.

An electronic delay element (4) is connected to the fuse head (3) and is configured to initiate the fuse head (3) upon reception of an initiation voltage from a blasting unit through wires (8). The fuse head (3) and the explosive charge (5) are located relative to each other such that the initiated fuse head (3) is capable to ignite the explosive charge (5). The electronic delay element (4) is an electronic circuit programmable to set a delay time between reception of the initiation voltage and initiation of the fuse head.

A sealing plug (6) is located closing the open end of the inner cavity. The lead wires (8) connecting the electronic initiator (1) and the blasting unit (11) are located entering the inner cavity through the sealing plug (6).

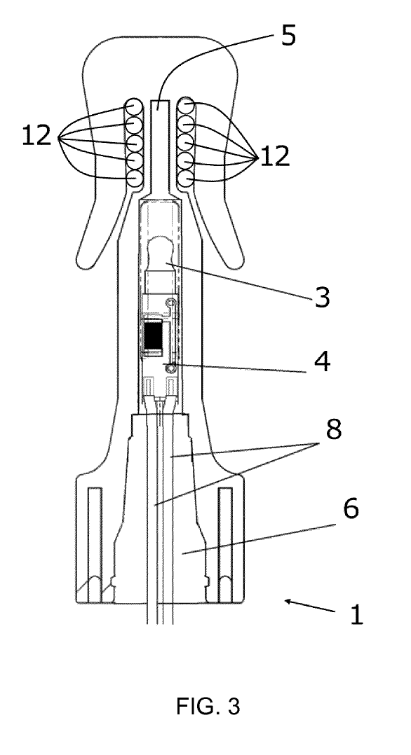

FIG. 3 shows the cross section of the electronic initiator of FIG. 2, in a use situation as the one schematically depicted in FIG. 1, in which the electronic initiator is retaining a number of shocktubes (12). As visible in the figure, five shocktubes (12) are received in each slot (7), each shocktube (12) being placed in the slot (7) adjacent to the explosive charge (5) and substantially perpendicular to the slot direction. Each shocktube (12), when connected to a corresponding non-electric detonator, is intended to transmit the blast initiated in the electronic initiator to the non-electric detonator.

In a use situation of the firing system, upon emission of an initiation signal from the control unit (11), the blasting unit (10) powers the electronic initiator (1) through wires (8) with an initiation voltage which is sufficient to initiate the fuse head (3). The electronic delay element (4) may be configured to set a delay time prior to the initiation of the fuse head. Initiation of the fuse head (3) causes ignition of the explosive charge (5), thus producing a blast which is transmitted through the shocktubes (12) to a number of non-electric detonators. The shocktubes (12) retained by the retaining means of the electronic initiator (1) are schematically shown in FIG. 1. The non-electric detonators connected to the shocktubes (12) are not shown.

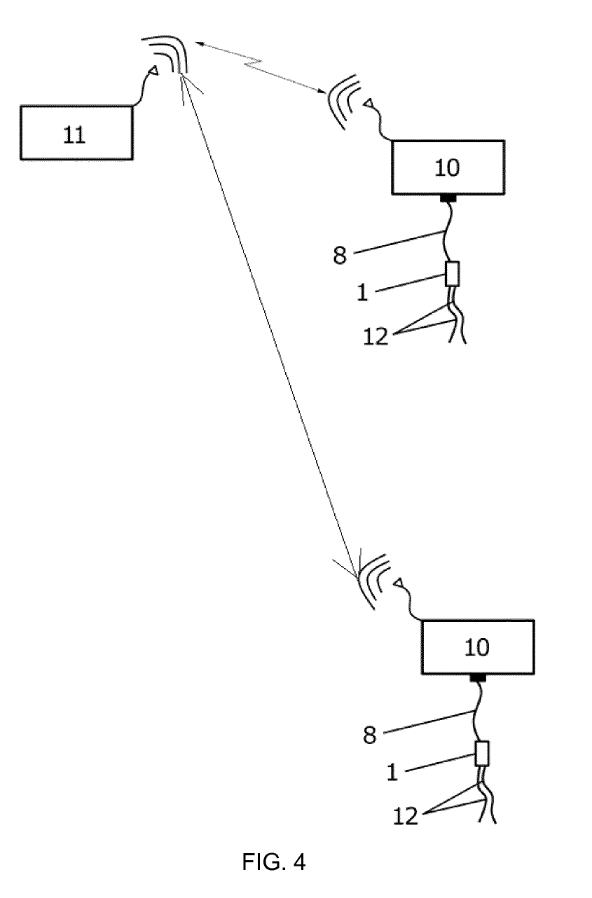

FIG. 4 shows a second embodiment of the firing system according to the invention. The firing system of this embodiment is like the one described in connection with FIG. 1, but in this embodiment the firing system includes a second blasting unit (10), in turn having an electronic initiator connected thereto. The presence of more than one blasting unit allows the firing system to assign time sequences between the blasting units. Additionally, in embodiments where each blasting unit is connected to several electronic initiators, time sequences can be assigned to the electronic initiators connected to each blasting unit, in order to define a sequence of blasts as required by the situation.

1. A firing system comprising:
at least one electronic initiator, and
a blasting unit connected to the at least one electronic initiator through at least one wire,
wherein the electronic initiator comprises an external housing, an explosive charge, a fuse head and an electronic delay element,
the external housing being made of plastics and comprising an inner cavity and retaining means adapted to retain at least one shocktube,
the explosive charge, the fuse head and the electronic delay element being located in the inner cavity of the external housing,
the explosive charge being located at a closed end of the inner cavity, at a position such that the explosive charge is capable to ignite the shocktubes retained by the retaining means in a use situation of the electronic initiator, and
the fuse head and the explosive charge being located relative to each other such that the fuse head is capable to ignite the explosive charge, and the electronic delay element being connected to the fuse head and configured to initiate it,
wherein the blasting unit is placed out of the external housing of the electronic initiator.

2. The firing system according to claim 1, wherein the electronic initiator further comprises a sealing plug located in the inner cavity, sealing an open end thereof.

3. The firing system according to claim 1, wherein the retaining means of the electronic initiator comprise at least one slot adapted to receive at least one shocktube.

4. The firing system according to claim 3, wherein the at least one slot is situated adjacent to the explosive charge.

5. The firing system according to claim 1, wherein the electronic delay element of the electronic initiator is an electronic circuit programmable to set a delay time.

6. The firing system according to claim 1, wherein the blasting unit is remotely controllable.

7. The firing system according to claim 1, further comprising a control unit adapted to remotely control the blasting unit to initiate the electronic initiator.

8. The firing system according to claim 1, comprising a plurality of electronic initiators connected to the blasting unit.

9. The firing system according to claim 8, wherein the electronic initiators are programmable to initiate respective blasts sequentially in time.

10. The firing system according to claim 1, comprising a plurality of blasting units and a plurality of electronic initiators, each blasting unit being connected to at least one electronic initiator.

11. The firing system according to claim 10, wherein the blasting units are programmable to initiate the electronic initiators sequentially in time.

12. The firing system according to claim 1, wherein the blasting unit comprises communication means configured to allow communication with at least one additional blasting unit.

13. The firing system according to claim 12, wherein the communication means are configured to operate in ad-hoc mode and/or in infrastructure network mode.

14. The firing system according to claim 1, wherein the weight of the explosive charge of an electronic initiator is less than 500 mg.
